(19) United States
(12) Patent Application Publication
(10) Pub. No.: US 2024/0050879 A1
(43) Pub. Date: Feb. 15, 2024

(54) SELF-LOCKING FILTER CARTRIDGE AND ASSEMBLY

(71) Applicant: Qingdao Ecopure Filter Co., Ltd., Qingdao (CN)

(72) Inventor: Zhibin Zou, Qingdao (CN)

(21) Appl. No.: 18/448,694

(22) Filed: Aug. 11, 2023

(30) Foreign Application Priority Data
Aug. 12, 2022 (CN) 202222114737.9

(51) Int. Cl. B01D 35/30; B01D 27/08

(52) U.S. Cl. CPC B01D 35/306; B01D 27/08; B01D 2201/302

(57) ABSTRACT

An exemplary filter cartridge has a housing enclosing a filter chamber and a filter element having a center channel, and a valve assembly having a coupling for engaging an adapter of a water filtration system, an inlet channel, a wastewater outlet valve, and a purified water outlet channel. The wastewater outlet valve has an outlet valve poppet that is biased to seal against an outlet valve housing by a biasing member and the purified water outlet channel extends through the outlet valve poppet. The purified water outlet channel is in fluid communication with an outlet tube that extends into the filter chamber through the center channel. The wastewater outlet valve is opened by one or more outer protrusions extending from the adapter.

### RELATED APPLICATIONS

The present application claims the benefit of and priority to Chinese Patent Application Serial No. 202222114737.9, filed on Aug. 12, 2022, entitled A SELF-LOCKING FILTER CARTRIDGE AND FILTER CARTRIDGE ASSEMBLY, the entire disclosure of which is incorporated herein by reference in its entirety.

### TECHNICAL FIELD

The present invention relates to water filtration devices, and, in particular, to self-locking filter cartridges and methods of using the same.

### BACKGROUND

Water filtration systems are increasingly used in everyday life in view of concerns over water pollution and contamination. Water filtration systems pass raw water through a filter to obtain purified water. Filters require periodic cleaning, replacement, or need to be removed during maintenance of the water filtration system. Some replaceable filters are formed as cartridges that contain the filter and a coupling so that the filter can be replaced by removing an existing cartridge and installing a new cartridge. Existing water filter cartridges are filled with water during use and during replacement of the cartridge or disassembly of the water filtration system water can leak out of the water filter cartridge and pollute the cabinet or splash on the user, resulting in a poor user experience.

### SUMMARY

The following is a brief summary of subject matter that is described in greater detail herein. This summary is not intended to be limiting as to the scope of the claims.

An exemplary filter cartridge has a housing and a valve assembly. The housing encloses a filter chamber and a filter element, the filter element comprising a center channel. The valve assembly includes a coupling for engaging an adapter of a water filtration system, an inlet channel fluidly connecting the coupling to the filter chamber, a wastewater outlet valve, and a purified water outlet channel extending through an outlet valve poppet of the wastewater outlet valve. The wastewater outlet valve is disposed in an outlet channel that is in fluid communication with the coupling and the filter chamber. The outlet valve poppet is biased to seal against an outlet valve housing by a biasing member. The purified water outlet channel is in fluid communication with an outlet tube that extends into the filter chamber through the center channel of the filter element. The outlet valve poppet is configured to be moved into an open condition by one or more outer protrusions extending from the adapter of the water filtration system.

An exemplary water filtration system has an adapter and a filter cartridge. The adapter has an inlet, an outlet, a cartridge receptacle in fluid communication with the inlet, and an outlet receptacle in fluid communication with the outlet, wherein the outlet receptacle includes a central protrusion and one or more outer protrusions. The exemplary filter cartridge has a housing and a valve assembly. The housing encloses a filter chamber and a filter element, the filter element comprising a center channel. The valve assembly includes a coupling for engaging an adapter of a water filtration system, an inlet channel fluidly connecting the coupling to the filter chamber, a wastewater outlet valve, and a purified water outlet channel extending through an outlet valve poppet of the wastewater outlet valve. The wastewater outlet valve is disposed in an outlet channel that is in fluid communication with the coupling and the filter chamber. The outlet valve poppet is biased to seal against an outlet valve housing by a biasing member. The purified water outlet channel is in fluid communication with an outlet tube that extends into the filter chamber through the center channel of the filter element. The outlet valve poppet is configured to be moved into an open condition by one or more outer protrusions extending from the adapter of the water filtration system.

A further understanding of the nature and advantages of the present invention are set forth in the following description and claims, particularly when considered in conjunction with the accompanying drawings in which like parts bear like reference numerals.

### BRIEF DESCRIPTION OF THE DRAWINGS

To further clarify various aspects of embodiments of the present disclosure, a more particular description of the certain embodiments will be made by reference to various aspects of the appended drawings. It is appreciated that these drawings depict only typical embodiments of the present disclosure and are therefore not to be considered limiting of the scope of the disclosure. Moreover, while the figures can be drawn to scale for some embodiments, the figures are not necessarily drawn to scale for all embodiments. Embodiments and other features and advantages of the present disclosure will be described and explained with additional specificity and detail through the use of the accompanying drawings in which:

FIG. 1 is a cross-sectional view of a proximal end of an exemplary filter cartridge and adapter in a coupled condition;

FIG. 2 is a cross-sectional view of the exemplary filter cartridge and adapter of FIG. 1 in an uncoupled condition;

FIG. 3 is a cross-sectional view of a housing of the exemplary filter cartridge of FIGS. 1-2;

FIG. 4 is a cross-sectional view of an outlet valve housing of the exemplary filter cartridge of FIGS. 1-2; and

FIG. 5 is a cross-sectional view of an outlet valve poppet of the exemplary filter cartridge of FIGS. 1-2.

### DETAILED DESCRIPTION

Various technologies pertaining to filtration systems and filter cartridges for water filtration systems are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “sealing element” or “sealing member” are intended to encompass components of an assembly that aid in the formation of an air-tight or a water-tight seal between two or more components. The sealing elements or sealing members can be formed from any suitable material, such as, for example, various elastomers, plastics, composite, metal, and other materials. Where the sealing element is arranged in an annular groove or channel or is disposed on a cylindrical member or within a cylindrical bore, the sealing element can take on the form of an O-ring. The sealing element can have any suitable cross-sectional shape, such as, for example, a circular, an elliptical, a rectangular, or a rounded polygonal cross-section. Additionally, as used herein, the term “exemplary” is intended to mean serving as an illustration or example of something and is not intended to indicate a preference.

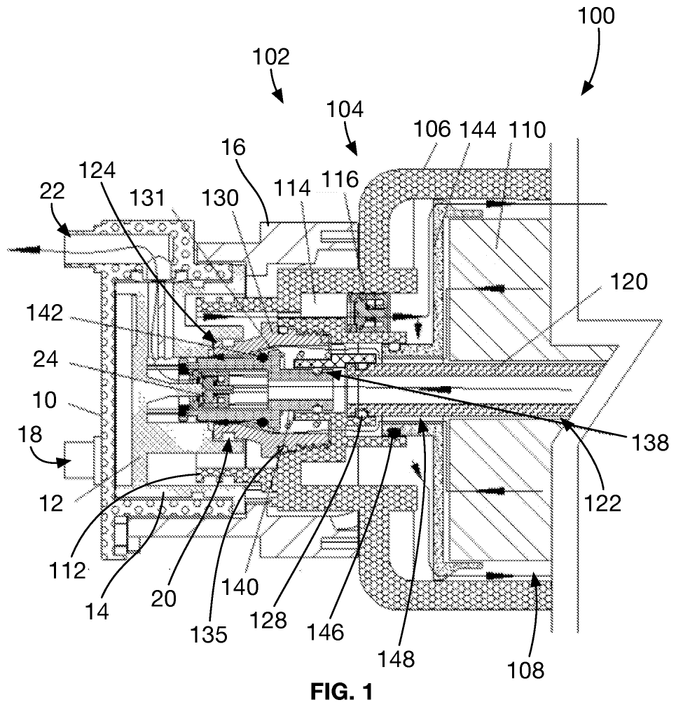

Referring now to FIG. 1-5, an exemplary filter cartridge 100 is shown. The filter cartridge 100 is a self-locking filter cartridge—i.e., water is prohibited from leaking out of the filter cartridge 100 when it is disassembled from a water filtration system 10, and more specifically, from an adapter 12 of the water filtration system 10. The water filtration system 10 can include a plurality of adapters 12 for receiving a plurality of filter cartridges 100 and can include other components, such as, for example, one or more valves, pumps, reservoirs, tanks, and other fluid system components that direct water through the filter cartridge 100 and then to a storage tank or into a water delivery system such as a pipes and tubes for delivering water to water faucets in a residential building.

Referring now to FIG. 1, the filter cartridge 100 is shown coupled to the adapter 12. The filter cartridge 100 extends from a proximal end 102 to a distal end (not shown). The proximal end 102 includes a valve assembly 104 for prohibiting flow into and out of the filter cartridge 100. A housing 106 of the filter cartridge extends from the proximal end 102 to the distal end and is generally cylindrical in shape. The distal end of the housing 106 opposite the proximal end 102 is sealed so that water only enters and exits the filter cartridge 100 through the valve assembly 104. The housing 106 forms a filter chamber 108 in which a filter element 110 is contained. While only the proximal end 102 of the filter cartridge 100 is shown, the filter cartridge 100—in particular, the housing 106 and filter chamber 108—can extend to any suitable length and be formed at any suitable diameter to accommodate differently sized filter elements 110 disposed within the housing 106.

The valve assembly 104 can be integrally formed in the housing 106 or can be a separate component that is attached to the housing 106. The valve assembly 104 includes an annular coupling 112 for connecting the filter cartridge 100 to the adapter 12. The coupling 112 removably connects to and forms a seal with a cartridge receptacle 14 of the adapter 12 via a repeatable connection, such as, for example, a push-on connection, a quarter-turn connection, a threaded connection, and the like. The connection between the coupling 112 of the filter cartridge 100 and the receptacle 14 of the adapter 12 forms the primary mechanical connection securing the filter cartridge 100 to the adapter 12, though additional and/or supplemental connections can be made to reinforce and support the primary connection, e.g., a support sleeve 16.

The valve assembly 104 includes an inlet channel 114 that fluidly connects the coupling 112 to a proximal end of the filter chamber 108. An inlet valve 116 allows unfiltered raw water to flow through the inlet channel 114 and into the filter chamber 108 and prohibits flow from the filter chamber 108 to the inlet channel 114. The inlet valve 116 can be a pressure-operated check valve that is normally closed and only allows water to flow through the valve when an inlet pressure exceeds a predetermined inlet pressure threshold. In other words, the inlet valve 116 prohibits the flow of unfiltered water out of the filter chamber 108 and only allows flow of unfiltered water into the filter chamber 108 when the filter cartridge 100 is attached to the adapter 12 and water pressure is applied to the filter cartridge 100 via the adapter 12.

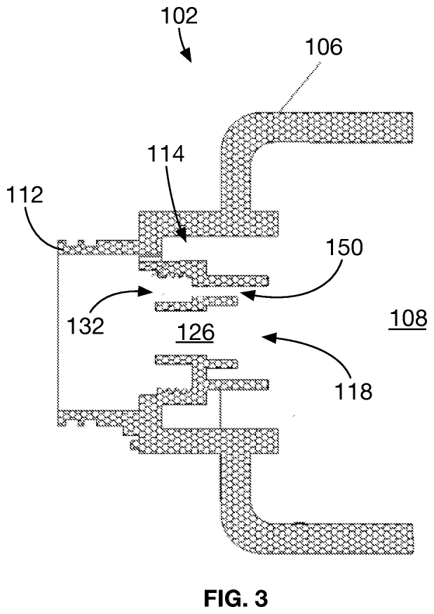

The valve assembly 104 also includes an outlet channel 118 (FIG. 3) that fluidly connects the distal end of the filter chamber 108 to the coupling 112. An outlet tube 120 extends through a center channel 122 of the filter element 110 to carry purified water out of the filter cartridge 100. The outlet tube 120 can include a plurality of perforations for receiving purified water permeating through the filter element 110 that is a reverse osmosis filter element. That is, the water pressure of the raw, unfiltered water passing through the reverse osmosis filter element 110 causes pure water to pass through a membrane into the perforated outlet tube 120. Purified, filtered water passes up the outlet tube 120 and through a purified water outlet 126 in the housing 106. An outlet tube sealing element 128 forms a seal between the outlet tube 120 and the housing 106.

An outlet valve assembly 152 is disposed in the outlet channel 118 to prohibit flow of the filtered water and the wastewater out of the filter cartridge 100 unless the filter cartridge 100 is assembled to the adapter 12. That is, the outlet valve assembly 152 includes a purified water outlet valve 154 and a wastewater outlet valve 124 that are both normally closed valves—i.e., valves that are biased to the closed condition. When the filter cartridge 100 is assembled to the adapter 12, the purified water outlet valve 154 and the wastewater outlet valve 124 are opened by features of the adapter 12 (described in greater detail below) to provide a flow path from the filter cartridge 100 through the adapter 12 to a water filtration system.

The filter element 110 has an annular cross-section with the center channel 122 extending along the entire length of the filter element 110 to accommodate the outlet tube 120, as described above. While the filter element 110 is shown with an annular cross-section, the filter element 110 can take on any suitable shape and is not limited to shapes that are rotationally symmetrical such as the cylindrical shape shown in the figures. The filter element 110 can be formed from any material suitable for filtering impurities out of water via, for example, reverse osmosis.

The filter element 110 is supported inside the housing 106 by an end cap 144 at the proximal end 102 of the filter cartridge 100. The end cap 144 includes a sealing element 146 for forming a water-tight seal between the end cap 144 and the housing 106 to form an annular wastewater channel 148 between the outlet tube 120 and the housing 106. The wastewater channel 148 is fluidly connected to the coupling 112 via a wastewater outlet 150 through the housing 106 and the wastewater outlet valve 124.

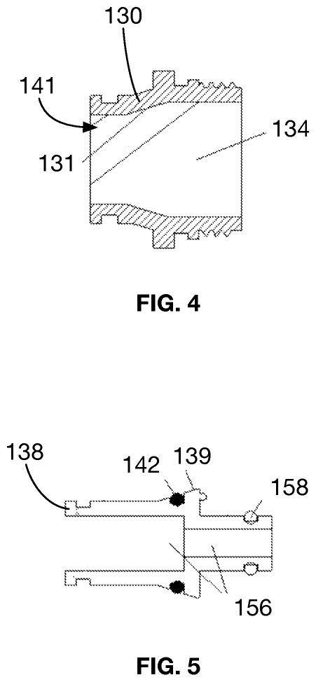

The wastewater outlet valve 124 includes a valve housing 130 that is fastened to an outlet valve socket 132 of the housing 106 of the filter cartridge 100 to form an outlet valve chamber 134 (FIG. 4). The valve housing 130 can be secured in the outlet valve socket 132 by any suitable means, such as, for example, a threaded connection, an adhesive connection, and a welded connection. A sealing element 135 is be provided between the outlet valve housing 130 and the outlet valve socket 132 to prohibit leakage between the wastewater outlet valve 124 and the housing 106 that could allow wastewater to mix with the unfiltered water entering the filter cartridge 100 through the coupling 112. As can be seen in FIG. 4, the valve chamber 134 has a larger diameter at the distal end that transitions to a smaller diameter at the proximal end that forms an outlet port 141 of the wastewater outlet valve 124. The sloped, frustoconical surface between the larger and smaller diameters of the valve chamber 134 forms a valve seat 131 of the wastewater outlet valve 124. In other words, the valve chamber 134 has a cylindrical distal portion, a conical or sloped middle portion, and a cylindrical proximal portion that has a diameter that is smaller than the diameter of the cylindrical distal portion.

An outlet valve poppet 138 is arranged in the outlet valve chamber 136. The outlet valve poppet 138 moveably engages the outlet port 141 of the wastewater outlet valve 124 to open and close the wastewater outlet valve 124. A biasing member 140 is disposed between the outlet valve socket 132 and the outlet valve poppet 138 to bias the outlet valve poppet 138 in a closing direction so that a sloped surface 139 of the outlet valve poppet 138 forms a seal with the seat 131 the outlet valve housing 130. The illustrated biasing member 140 is a coil spring that fits around a portion of the housing 106 and the outlet valve poppet 138 and is disposed within the outlet valve housing 130. The outlet valve poppet 138 can optionally include a sealing element 142 for forming a seal with the seat 131 of the outlet valve housing 130. The outlet valve 124 remains closed when the filter cartridge 100 is uncoupled from the adapter 12, thereby prohibiting the leakage of water from the filter cartridge 100 during maintenance of a water filtration system employing the filter cartridge 100.

The outlet valve poppet 138 further includes a purified water channel 156 (FIG. 5) that is in fluid communication with the outlet tube 120 and extends the entire length of the outlet valve poppet 138 to provide a flow path for filtered water to pass through the outlet valve assembly 152. The purified water outlet valve 154 is a one-way valve that is arranged within the purified water channel 156. The purified water outlet valve 154 can be a normally closed check valve that only allows water to flow through the valve when the purified water outlet valve 154 is engaged by the adapter 12. A poppet sealing element 158 provides a seal between the outlet valve poppet 138 and the housing 106 to prohibit leakage between the wastewater and the filtered water.

When the filter cartridge 100 is coupled to the adapter 12, as shown in FIG. 1, unfiltered water supplied through an inlet 18 of the adapter can cause the inlet valve 116 to open by exceeding the inlet pressure threshold. The inlet pressure threshold is typically set below the water pressure for a residential water system so that house water pressure will cause the one-way inlet valve to open. The unfiltered water flows through the inlet channel 114 and into the filter chamber 108 to fill the filter chamber 108.

Connecting the filter cartridge 100 to the adapter 12 forms a seal between the outlet valve assembly 152 and an outlet receptacle 20 of the adapter 12 and simultaneously opens the purified water outlet valve 154 and the wastewater outlet valve 124 to allow water to flow out of the filter cartridge 100. The outlet receptacle 20 of the adapter 12 is in fluid communication with an outlet 22 of the adapter 12. As the adapter 12 engages the outlet receptacle 20, a central protrusion or driving structure 24 extending from the outlet receptacle 20 engages and opens the purified water outlet valve 154. Simultaneously, a proximal end of the outlet valve poppet 138 is engaged by one or more outer protrusions or driving structures 26 to cause the biasing member 140 to compress so that the sealing element 142 is moved away from the seat 131 of the wastewater outlet valve 124, thereby opening the wastewater outlet valve 124.

Water pressure supplied at the inlet 18 of the adapter 12 causes the unfiltered water to flow through the filter element 110 in the filter chamber 108 to remove impurities and contamination from the water. The filtered or purified water exiting the distal end of the filter element 110 passes into the outlet tube 120 and flows in a proximal direction through the outlet tube 120 and outlet valve 124 and to the outlet 22 of the adapter 12, thereby providing filtered water to the water filtration system 10. Wastewater having a higher concentration of impurities flows through the wastewater outlet valve 124 and can be captured and directed to a drain of the water filtration system 10.

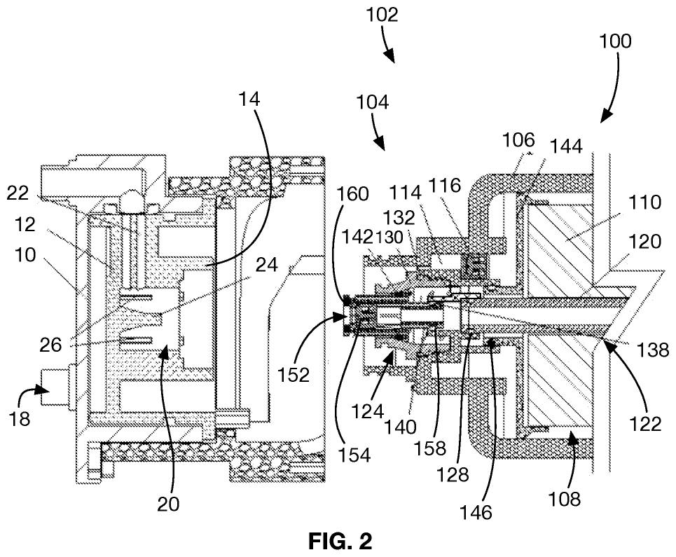

Referring again to FIG. 2, when the filter cartridge 100 is uncoupled from the adapter 12 of the water filtration system 10, the inlet valve 116, the wastewater outlet valve 124, and the purified water outlet valve 154 transition to a closed condition. That is, the inlet valve 116 remains closed without water pressure applied to the to the inlet valve 116 via the inlet channel 114. Similarly, the outlet valve poppet 138 remains sealed against the outlet valve housing 130 by the biasing member 140 and the purified water outlet valve 154 similarly remains closed. Thus, the filter cartridge 100 is a self-locking filter cartridge 100 that prohibits water leakage when the cartridge 100 is removed from the water filtration system 10. That is, unlike existing water filter cartridges, the exemplary filter cartridge 100 disclosed herein retains any water present therein when being disassembled from the water filtration system 10 to reduce or eliminate messes resulting from filter cartridge replacement or other maintenance being performed on the water filtration system.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed:

1. A filter cartridge, comprising:
a housing enclosing a filter chamber and a filter element disposed therein, wherein the filter element comprises a center channel;
a valve assembly comprising:
a coupling configured to engage an adapter of a water filtration system;
an inlet channel that is in fluid communication with the coupling and the filter chamber;
a wastewater outlet valve disposed in an outlet channel that is in fluid communication with the coupling and the filter chamber, wherein the wastewater outlet valve comprises an outlet valve poppet that is biased to seal against an outlet valve housing by a biasing member; and
a purified water outlet channel extending through the outlet valve poppet, wherein the purified water outlet channel is in fluid communication with an outlet tube that extends into the filter chamber through the center channel of the filter element;
wherein the outlet valve poppet is configured to be moved into an open condition by one or more outer protrusions extending from an adapter of a water filtration system.

2. The filter cartridge of claim 1, further comprising an inlet valve disposed in the inlet channel, wherein the inlet valve is configured to be opened by water pressure applied to the inlet valve via the inlet channel.

3. The filter cartridge of claim 1, further comprising a purified water outlet valve, wherein the purified water outlet valve is configured to be moved into an open condition by a central protrusion extending from the adapter.

4. The filter cartridge of claim 3, wherein the central protrusion and the one or more outer protrusions simultaneously cause the wastewater outlet valve and the purified water outlet valve to open when the filter cartridge is coupled to the adapter.

5. The filter cartridge of claim 1, wherein the inlet channel is offset from a center of the valve assembly.

6. The filter cartridge of claim 1, wherein the outlet channel is in a center of the valve assembly.

7. The filter cartridge of claim 1, wherein the wastewater outlet valve comprises an outlet valve housing that is connected to an outlet valve socket integrally formed in the housing of the filter cartridge.

8. The filter cartridge of claim 7, wherein the outlet valve housing comprises an outlet valve chamber having a frustoconical valve seat for forming a seal with the outlet valve poppet.

9. The filter cartridge of claim 8, wherein the outlet valve poppet comprises a seal member for forming a seal with the valve seat of the outlet valve housing.

10. The filter cartridge of claim 1, wherein the outlet tube and the outlet valve poppet comprise seal elements for forming a seal with a purified water outlet of the housing.

11. The filter cartridge of claim 1, wherein the filter element is a reverse osmosis filter, and the outlet tube comprises a plurality of perforations.

12. A water filtration system comprising:
an adapter comprising an inlet, an outlet, a cartridge receptacle in fluid communication with the inlet, and an outlet receptacle in fluid communication with the outlet, wherein the outlet receptacle includes a central protrusion and one or more outer protrusions;
a filter cartridge, comprising:
a housing enclosing a filter chamber and a filter element disposed therein, wherein the filter element comprises a center channel;
a valve assembly comprising:
a coupling configured to engage an adapter of a water filtration system;
an inlet channel that is in fluid communication with the coupling and the filter chamber;
a wastewater outlet valve disposed in an outlet channel that is in fluid communication with the coupling and the filter chamber, wherein the wastewater outlet valve comprises an outlet valve poppet that is biased to seal against an outlet valve housing by a biasing member; and
a purified water outlet channel extending through the outlet valve poppet, wherein the purified water outlet channel is in fluid communication with an outlet tube that extends into the filter chamber through the center channel of the filter element;
wherein the outlet valve poppet is configured to be moved into an open condition by one or more outer protrusions extending from an adapter of a water filtration system.

13. The filter cartridge of claim 12, further comprising an inlet valve disposed in the inlet channel, wherein the inlet valve is configured to be opened by water pressure applied to the inlet valve via the inlet channel.

14. The filter cartridge of claim 12, further comprising a purified water outlet valve, wherein the purified water outlet valve is configured to be moved into an open condition by a central protrusion extending from the adapter.

15. The filter cartridge of claim 12, wherein the central protrusion and the outer protrusion simultaneously cause the wastewater outlet valve and the purified water outlet valve to open when the filter cartridge is coupled to the adapter.

16. The filter cartridge of claim 12, wherein the inlet channel is offset from a center of the valve assembly.

17. The filter cartridge of claim 12, wherein the outlet channel is in a center of the valve assembly.

18. The filter cartridge of claim 12, wherein the wastewater outlet valve comprises an outlet valve housing that is connected to an outlet valve socket integrally formed in the housing of the filter cartridge.

19. The filter cartridge of claim 18, wherein the outlet valve housing comprises an outlet valve chamber having a frustoconical valve seat for forming a seal with the outlet valve poppet.

20. The filter cartridge of claim 19, wherein the outlet valve poppet comprises a seal member for forming a seal with the valve seat of the outlet valve housing.

21. The filter cartridge of claim 12, wherein the outlet tube and the outlet valve poppet comprise seal elements for forming a seal with a purified water outlet of the housing.

22. The filter cartridge of claim 12, wherein the filter element is a reverse osmosis filter, and the outlet tube comprises a plurality of perforations.
